(19) United States
(12) Patent Application Publication
(10) Pub. No.: US 2014/0094571 A1
(43) Pub. Date: Apr. 3, 2014

(54) POLYURETHANE ON THE BASIS OF SOFT THERMOPLASTIC POLYURETHANE

(71) Applicant: BASF SE, Ludwigshafen (DE)

(72) Inventors: Marine BOUDOU, Osnabrueck (DE); Frank PRISSOK, Lemfoerde (DE); Oliver Steffen HENZE, Damme (DE); Alfons BERTELS, Diepholz (DE)

(73) Assignee: BASF SE, Ludwigshafen (DE)

(21) Appl. No.: 14/093,746

(22) Filed: Dec. 2, 2013

Related U.S. Application Data
(63) Continuation of application No. 13/377,908, filed on Dec. 13, 2011, now abandoned.

(30) Foreign Application Priority Data
Jun. 23, 2009 (EP) 09163511.0

(51) Int. Cl. C08L 75/04; C08G 18/83

(52) U.S. Cl. CPC C08L 75/04; C08G 18/833
USPC 525/458; 525/457; 264/328.1; 264/109; 264/175; 264/176.1

(57) ABSTRACT

The invention relates to polyurethanes based on a thermoplastic polyurethane and an isocyanate concentrate having a functionality greater than 2 and less than 10 added to the thermoplastic polyurethane, wherein the hard phase content of the thermoplastic polyurethane is in the range from 0% to 5% and the isocyanate concentrate is added in an amount of at least 2% by weight based on the polyurethane PU-1.

This application is a continuation of U.S. application Ser. No. 13/377,908 filed Dec. 13, 2011, which is a National Stage of PCT/EP2010/058763 filed Jun. 22, 2010, both of which are incorporated herein by reference. This application also claims the benefit of EP 09163511.0 filed Jun. 23, 2009.

### DESCRIPTION

The invention relates to a polyurethane based on a thermoplastic polyurethane and an added polyisocyanate, a process for producing the polyurethanes of the invention and also their use.

The production of thermoplastic polyurethanes, hereinafter also referred to as TPUs for short, is generally known. TPUs are partially crystalline materials and belong to the class of thermoplastic elastomers. A characteristic of polyurethane elastomers is the segmented structure of the macromolecules. Owing to the different cohesion energy densities of these segments, phase separation into crystalline “hard” and amorphous “soft” regions occurs in the ideal case. The resulting two-phase structure determines the property profile of TPUs. Thermoplastic polyurethanes are polymers having a wide range of uses. Thus, for example, TPUs are used in the automobile industry, e.g. in dashboard skins, in films, in cable sheathing, in the leisure industry, as setting-down places, as functional and design elements in sports shoes, as soft component in hard-soft combinations and in a variety of further applications.

To improve the property profile of TPU, the literature discloses introducing crosslinks into the TPU which lead to an increase in the strengths, an improvement in the heat distortion resistance, a reduction in tensile set and compression set, and an improvement in resistance to media of all types, rebound resilience and creep behavior.

Known crosslinking methods are, inter alia, UV or electron beam crosslinking, crosslinking via siloxane groups and the formation of crosslinks by addition of isocyanates to the molten TPU. The reaction of a TPU, preferably in the molten state, with compounds having isocyanate groups is also referred to as prepolymer crosslinking and is generally known from, for example, WO 2005/054322 A2 and WO 2006/134138 A1. The modification of the hard and soft phases comprised in the thermoplastic polyurethanes is already known from WO 03/014179 A1 and WO 01/12692 A1.

A disadvantage of the known thermoplastic polyurethanes for particular applications is their mechanical properties, particularly in respect of compression set and the bending angle.

It was an object of the invention to provide polyurethanes which have improved mechanical properties. In particular, compression set and bending angle should be improved.

The present invention provides polyurethanes PU-E based on a thermoplastic polyurethane PU-1 and an isocyanate IC-1 which is added to the thermoplastic polyurethane PU-1, preferably with reaction, and is preferably an isocyanate concentrate having a functionality of greater than 2, wherein the PU-1 has a hard phase content of from 0% to 5%, in particular from 2% to 4%, and the isocyanate IC-1 which is preferably an isocyanate concentrate is added in an amount of from at least 2% by weight to 20% by weight, particularly preferably from 3% by weight to 15% by weight, in particular from at least 3% by weight to 10% by weight, based on the polyurethane PU-1.

In a preferred embodiment, the isocyanate concentrate IC-1 comprises from 20% by weight to 70% by weight, preferably from 25% by weight to 70% by weight, more preferably from 30% by weight to 60% by weight, even more preferably from 35% by weight to 60% by weight, of isocyanate dissolved in a thermoplastic. The isocyanate of the isocyanate concentrate IC-1 is more preferably dissolved in the thermoplastic polyurethane PU-2. The % by weight are based on the total weight of the thermoplastic, preferably the thermoplastic polyurethane PU-2, comprising the isocyanate. This means that the isocyanate is present in solution in the isocyanate concentrate and that the isocyanate has virtually not reacted at all with the thermoplastic of the preferably thermoplastic polyurethane PU-2. Not reacted means that at least 60%, preferably at least 80%, more preferably at least 90%, even more preferably at least 95% and very particularly preferably at least 99%, of the isocyanate has not reacted with the thermoplastic in the isocyanate concentrate IC-1. This percentage content is determined by setting the theoretical content of isocyanate groups determined on the basis of the added isocyanate (theoretical NCO content) to 100%. The content of free isocyanate groups actually comprised in the isocyanate concentrate (actual NCO content) is subsequently determined and calculated as a percentage of the theoretical NCO content. A preferred method of determining the actual NCO conent is given in Example 7.

The isocyanate concentrate IC-1 particularly preferably has an NCO content of greater than 5% and less than 70%, particularly preferably greater than 8% and less than 40%.

As isocyanates in the isocyanate concentrate IC-1 according to the invention, it is possible to use generally known isocyanates, for example aliphatic, cycloaliphatic and/or aromatic isocyanates, preferbly having from 2 to 10 isocyanate groups, particularly preferably from 2 to 5 isocyanate groups and in particular 3 isocyanate groups.

Preference is likewise given to the isocyanates being present in the form of isocyanurates which preferably have from two to eight, more preferably from 2 to 5 and particularly preferably three, isocyanate groups. In another preferred embodiment, the isocyanates are present in the form of prepolymers having from 2 to 10 isocyanate groups. To form prepolymers, isocyanates are reacted with compounds which are reactive toward isocyanates, preferably alcohols, and then have from 2 to 10 isocyanate groups.

In a further preferred embodiment, at least 2 of the preferred embodiments of the isocyanate concentrate, i.e. isocyanates and isocyanurates, isocyanates and prepolymers or prepolymers and isocyanurates are present side by side. In a preferred embodiment, isocyanates, prepolymers and isocyanurates are present side by side.

As isocyanates for producing the isocyanate concentrate IC-1, particular preference is given to diphenylmethane 2,2′-, 2,4′- and/or 4,4′-diisocyanate (MDI), a carbodiimide-modified diphenylmethane 2,2′-, 2,4′- and/or 4,4′-diisocyanate (MDI), a prepolymer based on diphenylmethane 2,2′-, 2,4′- and/or 4,4′-diisocyanate (MDI), preferably a prepolymer having an NCO content of from 20 to 25% and a viscosity at 25° C. of from 500 to 1000 mPas determined in accordance with DIN 53018, isocyanates having biuret and/or isocyanurate groups, particularly preferably isocyanurate having an NCO content of from 20 to 25% and a viscosity at 23° C. of from 2.5 to 4 Pas determined in accordance with DIN EN ISO 3219, in particular based on hexamethylene diisocyanate (HDI).

In a preferred embodiment, at least two isocyanates are comprised in the isocyanate concentrate IC-1. The functionality in the isocyanate concentrate IC-1 is then preferably in the range from 2 to 8, more preferably from 2 to 6 and particularly preferably from 2.5 to 4.

The functionality indicates the average number of isocyanate groups (NCO groups) per molecule.

Particular preference is given to carbodiimide-modified diphenylmethane 4,4′-diisocyanate (MDI), particularly preferably having an isocyanate content of from 25 to 33% by weight, in particular 29.5% by weight, for example Lupranat® MM 103 (BASF Aktiengesellschaft), prepolymer based on ethylene oxide/propylene oxide, preferably having a molecular weight in the range from 0.4 to 0.6 kg/mol, in particular having a molecular weight of 0.45 kg/mol, preferably having an isocyanate content of from 20 to 28% by weight, in particular 23% by weight, for example Lupranat® MP 102 (BASF Aktiengesellschaft), and/or a trimerized hexamethylene diisocyanate, preferably having an isocyanate content of from 20 to 28% by weight, in particular 23% by weight, for example Basonat® HI 100 (BASF Aktiengesellschaft).

The isocyanate concentrate IC-1 based on a thermoplastic, preferably a thermoplastic polyurethane PU-2, can be produced by all methods known to those skilled in the art. For example, it is possible to melt a thermoplastic polyurethane and subsequently incorporate the isocyanate, preferably homogeneously, into the thermoplastic polyurethane melt. The resulting thermoplastic polyurethane melt should preferably have a temperature of from 120° C. to 160° C. Particular preference is given to melting the thermoplastic polyurethane PU-2 used for the isocyanate concentrate at a temperature of from 170° C. to 280°, preferably from 170° C. to 240° C., and subsequently mixing the isocyanate having a temperature of from 20° C. to 80° C. into this melt, so that the resulting mixture, viz. the isocyanate concentrate IC-1, has a temperature below 160° C., preferably from 120° C. to 160° C. Such incorporation at a target temperature below 160° C. offers the advantage that degradation of the thermoplastic polyurethane by addition of diisocyanates or crosslinking of the thermoplastic polyurethane by introduction of triisocyanates or polyisocyanates can be avoided at this temperature.

The isocyanate is preferably incorporated into the thermoplastic polyurethane by means of an extruder, preferably by means of a twin-screw extruder. The product which can be obtained from the extruder, corresponding to isocyanate concentrate IC-1, i.e. the thermoplastic polyurethane comprising isocyanate, can preferably cool in a water bath immediately after exiting from the die of the extruder and the strand obtained can subsequently be, for example, pelletized by generally known methods.

In a preferred embodiment, the isocyanate concentrate IC1 leaving the extruder is expressed through a multihole die directly from the extruder into a water bath and subsequently chopped by means of a rotating knife, forming small pellets. This procedure is also referred to as underwater pelletization.

The hard phase content is calculated according to

$$HP ( \% ) = \frac{( {n}_{CE} \times {M}_{ISO} ) + {m}_{CE}}{{m}_{total}} \times 100 \qquad FORMULA 1$$

where
HP (%): hard phase content in percent
n_{CE}: moles of chain extender
M_{ISO}: number average molecular weight of isocyanate in gram per mol
m_{CE}: weight in gram of chain extender
mₜₒₜₐₗ: total weight in gram of chain extender, isocyanate and polyol

In a particularly preferred embodiment, the thermoplastic polyurethane PU-E has an index of from 1100 to 1600.

The index is defined as the molar ratio of the total isocyanate groups of the component (a) used in the reaction to the groups which are reactive toward isocyanates, i.e. the active hydrogens, of the components (b) and any chain extender (c). Here, “any” means that the chain extender is always taken into account when it is added. At an index of 1000, there is one active hydrogen atom, i.e. a function which is reactive toward isocyanates, of the components (b) and (c) per isocyanate group of the component (a). At indices above 1000, there are more isocyanate groups present than groups having active hydrogen atoms, e.g. OH groups.

Components to be used according to the invention:

Unless indicated otherwise, the following information refers to the polyurethanes and the components used for forming them and also to the polyurethanes PU-E and to the thermoplastic polyurethanes PU-1 and PU-2.

Processes for producing polyurethanes are generally known. The polyurethanes are preferably produced by reacting (a) isocyanates with (b) compounds which are reactive toward isocyanates and have a number average molecular weight of from 0.5 kg/mol to 12 kg/mol and preferably with (c) chain extenders having a number average molecular weight of from 0.05 kg/mol to 0.499 kg/mol, optionally in the presence of (d) catalysts and/or (e) customary auxiliaries.

Preferred starting components and processes for producing preferred polyurethanes are presented by way of example below. The components of (a) isocyanates, (b) compounds which are reactive toward isocyanates, (c) chain extenders and optionally (d) catalysts and/or (e) customary auxiliaries which are, by way of example, preferred in the production of these polyurethanes will be described below. The isocyanates (a), the compounds (b) which are reactive toward isocyanate and, if used, the chain extenders (c) are also referred to as formative components.
a) As organic isocyanates (a), it is possible to use generally known isocyanates, preferably aromatic, aliphatic, cycloaliphatic and/or araliphatic isocyanates, more preferably diisocyanates, preferably diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethylbiphenyl diisocyanate, 1,2-diphenylethane diisocyanate and/or phenylene diisocyanate, trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate (H12MDI); more preferably diphenylmethane 2,2′-, 2,4′- and/or 4,4′-diisocyanate (MDI), naphthylene 1,5-diisocyanate (NDI), tolylene 2,4- and/or 2,6-diisocyanate (TDI), hexamethylene diisocyanate (HDI), dicyclohexylmethane 4,4′-, 2,4′- and 2,2′-diisocyanate (H12MDI) and/or 1-isocyanato-3,3,5-trimethyl-5-isocyanatomethylcyclohexane IPDI, particularly preferably 4,4′-MDI. In a preferred embodiment, only one isocyanate is used for producing a polyurethane, while in another preferred embodiment at least 2 different isocyanates are used for producing the polyurethane.
b) As compounds (b) which are reactive toward isocyanates, it is possible to use generally known compounds which are reactive toward isocyanates, preferably polyesterols, polyetherols and/or polycarbonatediols, which are also summarized under the term “polyols”, having number average molecular weights of from 0.5 kg/mol to 12 kg/mol, preferably from 0.6 kg/mol to 6 kg/mol, in particular from 0.8 kg/mol to 4 kg/mol, and preferably an average functionality of from 1.8 to 2.3, preferably from 1.9 to 2.2, in particular 2. The average functionality here indicates the number of groups in a mixture which are on average present per molecule and react with the isocyanate groups. These polyols form the soft phase component.
c) As chain extenders (c), it is possible to use generally known aliphatic, araliphatic, aromatic and/or cycloaliphatic compounds, preferably having a number average molecular weight of from 0.05 kg/mol to 0.499 kg/mol, preferably 2-functional compounds, i.e. molecules having two groups which are reactive toward isocyanate groups. Preference is given to diamines and/or alkanediols having from 2 to 10 carbon atoms in the alkylene radical, in particular 1,4-butanediol, 1,6-hexanediol, 1,3-propanediol, 1,2-ethylene glycol and/or dialkylene, trialkylene, tetraalkylene, pentaalkylene, hexaalkylene, heptaalkylene, octaalkylene, nonaalkylene and/or decaalkylene glycols having up to 8 carbon atoms, preferably corresponding oligopropylene and/or polypropylene glycols, with mixtures of the chain extenders also being used in a preferred embodiment. The chain extenders (c) together with the isocyanates (a) form the hard phase component.
d) Suitable catalysts (d) which, in particular, accelerate the reaction between the NCO groups of the isocyanates (a), preferably of the diisocyanates, and the hydroxyl groups of the formative components (b) and (c) are the customary tertiary amines known from the prior art, preferably triethylamine, dimethylcyclohexylamine, N-methylmorpholine, N,N′-dimethylpiperazine, 2-(dimethylaminoethoxy)ethanol, diazabicyclo[2.2.2]octane and the like, and also, in particular, organic metal compounds such as titanic esters, iron compounds, preferably iron(III) acetylacetonate, tin compounds, preferably tin diacetate, tin dioctoate, tin dilaurate or the dialkyltin salts of aliphatic carboxylic acids, preferably dibutyltin diacetate, dibutyltin dilaurate or the like. The catalysts are usually used in amounts of from 0.00001 to 0.1 part by weight per 100 parts by weight of polyhydroxyl compound (b).
e) Apart from catalysts (d), customarily auxiliaries (e) are also added to the formative components (a) to (c) in preferred embodiments. Mention may be made by way of example of surface-active substances, flame retardants, nucleating agents, oxidation stabilizers, lubricants and mold release agents, dyes and pigments, stabilizers, e.g. against hydrolysis, light, heat or discoloration, inorganic and/or organic fillers, reinforcing materials and plasticizers.
   As hydrolysis inhibitors, preference is given to using oligomeric and/or polymeric aliphatic or aromatic carbodiimides. To stabilize the TPUs of the invention against aging, stabilizers are preferably added to the TPU. For the purposes of the present invention, stabilizers are additives which protect a polymer or a polymer mixture against harmful environmental influences. Examples are primary and secondary antioxidants, “hindered amine light stabilizers”, UV absorbers, hydrolysis inhibitors, quenchers and flame retardants. Examples of commercial hydrolysis inhibitors and stabilizers may be found, for example, in Plastics Additive Handbook, 5th Edition, H. Zweifel, ed., Hanser Publishers, Munich, 2001 ([1]), p. 98-p. 136.
   If the TPU of the invention is exposed to thermooxidative damage during use, antioxidants can be added. Preference is given to using phenolic antioxidants. Examples of phenolic antioxidants are given in Plastics Additive Handbook, 5th edition, H. Zweifel, ed, Hanser Publishers, Munich, 2001, pp. 98-107 and pp. 116-121. Preference is given to phenolic antioxidants whose number average molecular weight is greater than 0.7 kg/mol. An example of a phenolic antioxidant which is preferably used is pentaerythrityl tetrakis(3-(3,5-bis(1,1-dimethylethyl)-4-hydroxyphenyl)propionate) (Irganox® 1010). The phenolic antioxidants are generally used in concentrations in the range from 0.1 to 5% by weight, preferably from 0.1 to 2% by weight, in particular from 0.5 to 1.5% by weight, in each case based on the total weight of the TPU.
   The TPUs are preferably additionally stabilized with a UV absorber. UV absorbers are molecules which absorb high-energy UV light and dissipate the energy. Customary UV absorbers which are used in industry belong, for example, to the group of cinnamic esters, diphenylcyanoacrylates, formamidines, benzylidene malonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122. In a preferred embodiment, the UV absorbers have a number average molecular weight of greater than 0.3 kg/mol, in particular greater than 0.39 kg/mol. Furthermore, the UV absorbers which are preferably used should have a number average molecular weight of not more than 5 kg/mol, particularly preferably not more than 2 kg/mol. A particularly suitable group of UV absorbers is the group of benzotriazoles. Examples of particularly suitable benzotriazoles are Tinuvin® 213, Tinuvin® 328, Tinuvin® 571 and Tinuvin® 384 and Eversorb® 82. The UV absorbers are preferably added in amounts in the range from 0.01 to 5% by weight, based on the total mass of TPU, particularly preferably from 0.1 to 2.0% by weight, in particular from 0.2 to 0.5% by weight, in each case based on the total weight of the TPU. A UV stabilization as described above based on an antioxidant and a UV absorber is often still not sufficient to ensure good stability of the TPU of the invention against the damaging influence of UV rays. In this case, a hindered amine light stabilizer (HALS) can be added, preferably in addition to the antioxidant and the UV absorber, to component (e) of the TPU of the invention. The activity of HALS compounds is based on their ability to form nitroxyl radicals which interfere in the mechanism of oxidation of polymers. HALSs are highly efficient UV stabilizers for most polymers. HALS compounds are generally known and are commercially available. Examples of commercially available HALS may be found in Plastics Additive Handbook, 5th edition, H. Zweifel, Hanser Publishers, Munich, 2001, pp. 123-136. As “hindered amine light stabilizers”, preference is given to hindered amine light stabilizers whose number average molecular weight is greater than 0.5 kg/mol. Furthermore, the number average molecular weight of the preferred HALS compounds should preferably be not more than 10 kg/mol, particularly preferably not more than 5 kg/mol. Particularly preferred hindered amine light stabilizers are bis(1,2,2,6,6-pentamethylpiperidyl)sebacate (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). The condensation product of 1-hydroxyethyl-2,2,6,6-tetramethyl-4-hydroxypiperidine and succinic acid (Tinuvin® 622) is particularly preferred when the titanium content of the product is <150 ppm, preferably <50 ppm, in particular <10 ppm. HALS compounds are preferably used in a concentration in the range from 0.01 to 5% by weight, particularly preferably from 0.1 to 1% by weight, in particular from 0.15 to 0.3% by weight, in each case based on the total weight of the TPU. Particularly preferred UV stabilization comprises a mixture of a phenolic stabilizer, a benzotriazole and an HALS compound in the above-described preferred amounts.

Further details regarding the abovementioned auxiliaries and additives may be found in the technical literature, e.g. Plastics Additive Handbook, 5th edition, H. Zweifel, ed, Hanser Publishers, Munich, 2001. All molecular weights mentioned in this text are number average molecular weights and have, unless indicated otherwise, the unit [kg/mol].

To adjust the hardness of the TPU, the formative components (b) and (c) can be varied within a relatively wide range of molar ratios. Molar ratios of component (b) to the total chain extenders (c) to be used of from 10:0 to 1:0.35 have been found to be useful, with the hardness of the TPU increasing with increasing quantities of (c).

The production of the TPUs can be carried out by the known processes either continuously, preferably using reaction extruders or the belt process by the one-shot process or the prepolymer process, or batchwise. Preference is likewise given to production via the prepolymer process. In this process, the components (a), (b) and optionally (c), (d) and/or (e) to be reacted are mixed with one another in succession or simultaneously, with the reaction commencing immediately. In the extruder process, the formative components (a), (b) and optionally (c) and also the components (d) and/or (e) are introduced individually or as a mixture into the extruder and reacted, preferably at temperatures of from 100° C. to 280° C., more preferably from 140° C. to 250° C. The TPU obtained is extruded, cooled and pelletized.

Owing to their particularly good compatibility, TPUs according to WO 03/014179 A1 are particularly suitable for producing both PU-E and PU-1. These documents are incorporated by reference into the present patent application. The following information up to the examples relates to these particularly preferred TPUs.

Particularly preferred polyurethanes are based on:
monomeric, polymeric, i.e. comprising at least two rings and/or comprising uretonimine which is a reaction product of carbodiimide and isocyanate, MDI as isocyanate and
a polyol component for the soft phase having a number average molecular weight of more than 0.5 kg/mol and less than 100 kg/mol, preferably from 0.6 kg/mol to 6 kg/mol, in particular from 0.8 kg/mol to 4 kg/mol,
a polyol component for the hard phase having a number average molecular weight of more than 0 kg/mol and not more than 0.499 kg/mol, in particular from 0.060 kg/mol to 0.15 kg/mol.

In a particularly preferred embodiment, the thermoplastic polyurethane PU-1 is based on an MDI as polyisocyanate and a polyesterol and/or polyetherol, in particular a polyester of adipic acid with butanediol and/or ethylene glycol and/or methylpropanediol.

In preferred embodiments, the polyurethanes PU-E according to the invention have at least one of the following properties:
The tensile strength is greater than 5 MPa, preferably greater than 10 MPa and particularly preferably greater than 20 MPa.
The elongation at break is greater than 200%, preferably greater than 300% and particularly preferably greater than 500%.
The tear propagation resistance is greater than 10 kN/m, preferably greater than 15 kN/m and particularly preferably greater than or equal to 25 kN/m.
The abrasion is less than 100 mm³, preferably less than 70 mm³ and particularly preferably less than 55 mm³.
The compression set is less than 40% at 23° C., preferably less than 30% and particularly preferably less than 24%.
The compression set at 70° C. is less than 50%, preferably less than 35% and particularly preferably less than 25%.
The bending angle at 23° C. is less than 50%, preferably less than 30% and particularly preferably less than 20%.
The parameters mentioned are determined by the test methods indicated in the examples.
In preferred embodiments, at least two of the abovementioned parameters are fulfilled, more preferably at least three, more preferably at least four, more preferably at least 5, even more preferably at least 6 and very particularly preferably all 7 of the abovementioned parameters are fulfilled. Here, any possible combination of parameters having the same or different degree of preference is encompassed by the disclosure content of the present text, e.g. “preferably” with “preferably” or else “preferably” with “particularly preferably”, etc., even if these combinations are not expressly mentioned for reasons of simplicity.
The polyurethanes of the invention very particularly preferably have a tensile strength of more than 20 MPa, an elongation at break of more than 500%, a tear propagation resistance of greater than or equal to 25 kN/m, an abrasion of less than 55 mm³, a compression set of less than 24% at 23° C. and of less than 25% at 70° C.

The polyurethanes PU-E of the invention preferably have an index IN in the range from 1100 to 1600, preferably from 1100 to 1500, particularly preferably from 1150 to 1450, where the index is calculated according to the formula 2:

$$IN = \frac{{n}_{ISO}}{{n}_{OH}} = \frac{{f}_{ISO 1} {n}_{ISO 1} + {f}_{ISO 2} {n}_{ISO 2}}{{f}_{P 1} {n}_{P 1} + {f}_{P 2} {n}_{P 2} + {f}_{KV} {n}_{CE}} \times 1000 \qquad FORMULA 2$$

where
IN: index
n_{ISO}: total number of moles of NCO-comprising molecules (isocyanates 1 and 2) in mol
n_{OH}: total number of moles of active hydrogen, in particular on OH-comprising molecules (chain extender and polyols 1 and 2) in mol
f_{ISO1}: functionality of isocyanate 1
n_{ISO1}: number of moles of isocyanate 1
f_{ISO2}: functionality of isocyanate 2
n_{ISO2}: number of moles of isocyanate 2
f_{P1}: functionality of polyol 1
n_{P1}: number of moles of polyol 1
f_{P2}: functionality of polyol 2
n_{P2}: number of moles of polyol 2
f_{CE}: functionality of chain extender
n_{CE}: number of moles of chain extender

The polyurethanes of the invention are particularly suitable for producing moldings, for example rollers, shoe soles, linings in automobiles, hoses, coatings, cables, profiles, laminates, plug connections, cable plugs, bellows, towing cables, scrapers, sealing lips, cable sheathing, seals, belts or damping elements, films or fibers, produced by injection molding, calendering, powder sintering or extrusion.

### EXAMPLES

The following components were used in the examples below:

TABLE 1

| Abbreviation | Composition |
|---|---|
| PU-E | PU-1 + IC-1 |
| IC-1.1 | PU-2 + prepolymer A |
| IC-1.2 | PU-2 + prepolymer B |
| Prepolymer A | s.b. |
| Prepolymer B | s.b. |
| PU-1.1 | s.b. |
| PU-1.2 | s.b. |
| PU-2 | s.b. |

Prepolymer A is a prepolymer based on uretonimine-comprising MDI as isocyanate component, dipropylene glycol and propylene glycol polyether diol having a number average molecular weight of 0.45 kg/mol as hydroxy component. The functionality of the prepolymer is 2.05 and the NCO content is 23 g/100 g (measured in accordance with ASTM 5155-96A).

Prepolymer B is a prepolymer based on polymeric MDI (PMDI) and monomeric MDI, based on about 39% by weight of monomeric MDI and 61% by weight of polymeric MDI, as isocyanate component and propylene glycol polyether diol having a number average molecular weight of 0.45 kg/mol as hydroxy component. The functionality of this polymer is 2.4 and the NCO content is 28.2 g/100 g.

PU-1.1 is a mixture of a polyester polyurethane based on 10.1% of MDI monomer, 0.7% of 1,4-butanediol and 59.3% of a polyester diol (butanediol-ethylene glycol-adipic acid with a 1:1 mixing ratio of the components butanediol/ethylene glycol) having a molecular weight of 2 kg/mol and a further high molecular weight polyurethane based on MDI, 1,4-butanediol and a polyester diol (butanediol-adipic acid) having a molecular weight of 2.5 kg/mol and 1% of polymeric carbodiimides as hydrolysis inhibitor, 1.5% of lubricant and antiblocking agent, 0.2% of phenolic antioxidant, 0.1% of phosphorus-based antioxidant and 0.1% of finely powdered talc. The hard phase content is 3.5% based on the base polyurethane (without the further high molecular weight polyurethane based on MDI monomer, 1,4-butanediol and a polyester diol (butanediol-adipic acid) having a molecular weight of 2.5 kg/mol. The proportion by weight of the further high molecular weight polyurethane is 27% of PU-1.1.

PU-1.2 is a mixture of a polyester polyurethane based on 10.2% of MDI, 0.7% of 1,4-butanediol and 38% by weight of a polyester diol (butanediol-methylpropanediol-adipic acid; 1/1 mixing ratio of the components butanediol/methylpropanediol) having a molecular weight of 3 kg/mol, 38% by weight of a polyester diol (butanediol-hexanediol-adipic acid; 2/1 mixing ratio of the components butanediol/hexanediol) having a molecular weight of 2 kg/mol, 10.4% by weight of a high molecular weight polyester based on terephthalic acid and butanediol, 1% of polymeric aliphatic carbodiimide as hydrolysis inhibitor, 0.8% of lubricant and antiblocking agent, 0.4% of phenolic antioxidant and 0.5% of finely powdered talc. The hard phase content is 2.8% based on the base polyurethane.

PU-2 is a polyester polyurethane based on MDI, 1,4-butanediol and a polyester diol (butanediol-hexanediol-adipic acid) having a number average molecular weight of 2 kg/mol. The hard phase content is 26%.

The isocyanate components IC-1.1 and IC-1.2 were produced by dissolving the isocyanate prepolymers as per Table 2 below in a thermoplastic polyurethane. The production method was as described in WO 2006/134138 A1:

A twin-screw extruder model ZE 40 A from Berstorff having a process section length of 35 D, divided into 10 barrel sections was used for producing the polyurethanes according to the invention. The screw element arrangement had two backward-conveying kneading blocks as melting unit for the pelletized thermoplastic polyurethane PU-1 in barrel section 2. Barrel sections 3, 6 and 7 had mixing elements in the form of toothed disk blocks in addition to conventional transport elements.

The barrel section temperatures were firstly all set to 210° C. and the isocyanate concentrate IC-1 was introduced continuously in the form of pellets based on thermoplastic polyurethane PU-2 by means of gravimetric metering into barrel section 1. Prepolymer A or B was then introduced continuously by means of a gear pump and gravimetric metering into the melt of the thermoplastic polyurethane PU-1 in barrel section 3 and intensively mixed in the subsequent barrel sections. After the addition of prepolymer A or B, all further barrel section temperatures from barrel section 4 onward were reduced to 150° C. After the optically clear melt extrudates leaving the extruder die head had reached temperatures of 150-160° C., these were cooled in a water bath, freed of adhering water by means of an extractor fan and pelletized in a conventional manner. This resulted in hard pellets which crystallized well and did not stick together and could be used without further drying (concentrate No. 1).

TABLE 2

| | Isocyanate IC-1.1 | Isocyanate IC-1.2 |
|---|---|---|
| Base TPU | PU-2 | PU-2 |
| Isocyanate prepolymer | prepolymer A | prepolymer B |
| Resulting NCO content of the | 9 | 10 |
| crosslinking reagent (%) | | |

The following experiments were carried out using these components:

### Example 1 (Comparison)

### PU 1.1

PU-1.1 pellets were processed by injection molding in a conventional manner 1) to give test plates (moldings: length: 125 mm; width: 90 mm), the test plates were heated at 100° C. for 20 hours and their mechanical properties were determined.

Tensile bars in accordance with DIN-EN-ISO 527-2, test specimens for determining the notched impact toughness in accordance with DIN-EN-ISO 179-1 and test plates were produced in one tool by means of injection molding. A screw piston injection molding machine, model Arburg 420 C, was available for this purpose. The machine and process parameters are as follows:
maximum closure force=100 kN
screw geometry: D=30 mm, L/D=25 (three-zone screw)
flight depth ratio 2.2:1
tool temperature 40° C.

### Example 2 (According to the Invention)

### PU-E1

PU-1.1 pellets were mixed with 8% of isocyanate IC-1.1 pellets, this mixture of pellets was processed by reaction injection molding to give test plates, the test plates were heated at 100° C. for 20 hours and their mechanical properties were determined. The results are shown in Table 3.

### Example 3 (According to the Invention)

### PU-E2

PU-1.1 pellets were mixed with 8% of isocyanate IC-1.2 pellets, this mixture of pellets was processed by reaction injection molding to give test plates, the test plates were heated at 100° C. for 20 hours and their mechanical properties were determined. The results are shown in Table 3.

### Example 4 (Comparison)

### PU-1.2

PU-1.2 pellets were processed by injection molding to give test plates, the test plates were heated at 100° C. for 20 hours and their mechanical properties were determined. The results are shown in Table 3.

### Example 5 (According to the Invention)

### PU-E3

PU-1.2 pellets were mixed with 8% of isocyanate IC-1.2 pellets, this mixture of pellets was processed by injection molding with reaction to give test plates, the test plates were heated at 100° C. for 20 hours and their mechanical properties were determined. The results are shown in Table 3.

### Example 6

### Test Method for Determining the Bending Angle

To determine the bending angle, a molding made of the appropriate polyurethane (length: 110 mm; width: 25 mm; height: 2 mm) was bent by 180° at the ends and stored between two steel plates having a thickness of 4 mm at 90° C. in an oven for 16 hours. The molding was subsequently taken from the oven and its deviation from straight was measured after 15 minutes at room temperature. The smaller the measured bending angle, the better is the corresponding material.

### Example 7

### Determination of the NCO Content

The isocyanate-comprising material used in the work is firstly dissolved in dichloromethane. The weight of sample should be adapted according to the NCO content to be expected. An amount in the range from about 50 mg (at an NCO content of from about 30% to 40%) to 500 mg (at an NCO content of from about 1% to 2%) is weighed accurately into a 10 ml volumetric flask, admixed with about 8 ml of dichloromethane and shaken to effect complete dissolution. The flask is subsequently made up with dichloromethane to the calibration mark.

50 ml of acetonitrile are placed in the titration vessel of the titration apparatus and 1 ml of the sample solution of the material is added. After placing the vessel in the apparatus, 10 ml of dibutylamine solution are added. The mixture is subsequently stirred for 5 minutes and the excess dibutylamine is backtitrated with 0.01 N hydrochloric acid. Duplicate determinations must always be carried out. At the same time, two blanks without the sample solution of the material are made up. The concentration of the hydrochloric acid is determined using sodium carbonate as titrimetric standard.

The difference between the hydrochloric acid consumption of blank and sample of material corresponds to the amine which has reacted with NCO. If this difference is not in the range from 1 to 9 ml, the determination has to be repeated using an appropriately lower or higher volume of sample solution of the material. 100 μl of a 0.01 N hydrochloric acid correspond to 42 μg of NCO. The result can also be reported in % of NCO or μg/g (×10 000) or mg/g (×10).

TABLE 3

| | | | Examples | | | | |
|---|---|---|---|---|---|---|---|
| | | | | 2 | 3 | | 5 |
| | | | 1 | According to | According to | 4 | According to |
| | | | Com- | the invention | the invention | Com- | the invention |
| | | | parison | PU-E1 | PU-E2 | parison | PU-E3 |
| | | | PU-1.1 | PU-1.1 + | PU-1.1 + | PU-1.2 | PU-1.2 + |
| Property | Unit | Test method | PU-1.1 | 8% IC-1.1 | 8% IC-1.2 | PU-1.2 | 8% IC-1.2 |
| Tensile strength | MPa | DIN 53 504 | 42 | 40 | 43 | 28 | 22 |
| Elongation at break | % | DIN 53 504 | 920 | 570 | 570 | 1060 | 620 |
| Tear propagation | kN/m | DIN ISO 34-1 | 47 | 44 | 34 | 38 | 25 |
| resistance | | | | | | | |
| Abrasion | mm³ | DIN ISO 4649 | 28 | 28 | 35 | 77 | 51 |
| Compression set | % | DIN ISO 815 | 24 | 19 | 19 | — | — |
| 72 h/23° C./30 min3 min | | | | | | | |
| Compression set | % | DIN ISO 815 | 45 | 18 | 18 | 52 | 23 |
| 24 h/70° C./30 min3 min | | | | | | | |
| Bending angle | ° | | 114 | 14 | 14 | 52 | 16 |

The results of the examples according to the invention display a significant decrease in the compression set and a significantly lower and thus better bending angle.

1. A polyurethane, comprising a thermoplastic polyurethane comprising an isocyanate concentrate having a functionality greater than 2 and less than 10,
wherein the thermoplastic polyurethane has a hard phase content of from 0 to 5% and has an isocyanate concentrate content of at least 2% by weight based on the thermoplastic polyurethane.

2. The polyurethane of claim 1, wherein the isocyanate concentrate comprises from 20% to 70% by weight of an isocyanate.

3. The polyurethane of claim 1, wherein the thermoplastic polyurethane has an index of from 1100 to 1600.

4. The polyurethane of claim 1, wherein the thermoplastic polyurethane further comprises:
a first polyol component having a number average molecular weight greater than 0.5 kg/mol and less than 12 kg/mol and an average functionality of from 1.8 to 2.3, as soft phase component; and
a second polyol component having a number average molecular weight of more than 0 kg/mol and not more than 0.499 kg/mol as a hard phase component,
wherein the isocyanate concentrate comprises at least one isocyanate selected from the group consisting of a diphenylmethane diisocyanate (MDI), naphthylene diisocyanate (NDI), a tolylene diisocyanate (TDI), hexamethylene diisocyanate (HDI), a dicyclohexylmethane diisocyanate (H12MDI) and isophorone diisocyanate (IPDI).

5. The polyurethane of claim 4, wherein the isocyanate concentrate comprises a diphenyl methane diisocyanate (MDI), the first polyol component comprises a polyesterol or a polyetherol, and the second polyol component comprises 1,4-butanediol.

6. The polyurethane of claim 1, wherein the polyurethane satisfies at least one parameter selected from the group consisting of:
a tensile strength greater than 5 MPa;
an elongation at break greater than 200%;
a tear propagation resistance greater than or equal to 10 kN/m;
an abrasion less than 100 mm³;
a compression set less than 40% at 23° C.;
a compression set less than 50% at 70° C.; and
a bending angle less than 50% at 23° C.

7. The polyurethane of claim 1, wherein the isocyanate concentrate comprises an isocyanate prepolymer dissolved in a second thermoplastic polyurethane.

8. The polyurethane of claim 7, wherein the first and second thermoplastic polyurethanes are identical.

9. The polyurethane of claim 7, wherein the isocyanate concentrate is a prepolymer comprising a diphenylmethane diisocyanate (MDI), which is present in at least one form selected from the group consisting of a modified form and a polymer form.

10. The polyurethane of claim 1, wherein the thermoplastic polyurethane has a hard phase content of from 1% to 4%.

11. A process for producing a polyurethane of claim 1, the process comprising:
mixing the thermoplastic polyurethane and the isocyanate concentrate to obtain a mixture; and then
melting and processing the mixture in an extruder or an injection mold.

12. The process of claim 11, wherein, during the mixing, the isocyanate concentrate is in the form of pellets.

13. A process for producing a polyurethane molding, the process comprising injection molding, calendaring, powder sintering, or extruding a polyurethane of claim 1, to obtain a molding.

14. A polymer blend or mixture, comprising: a polyurethane of claim 1; and a second polymer, wherein a content of the second polymer is from 5 to 40%, based on a total weight of the polyurethane and second polymer.

15. A film, an injection-molded article, or an extruded article comprising a polyurethane of claim 1.

16. The polyurethane of claim 1, wherein the isocyanate concentrate comprises from 25% to 70% by weight of an isocyanate.

17. The polyurethane of claim 1, wherein the isocyanate concentrate comprises from 35% to 60% by weight of an isocyanate.

18. The polyurethane of claim 1, wherein the isocyanate concentrate content is from 3% to 15% by weight based on the thermoplastic polyurethane.

19. The polyurethane of claim 1, wherein the isocyanate concentrate content is from 3% to 10% by weight based on the thermoplastic polyurethane.

20. The polyurethane of claim 1, wherein the thermoplastic polyurethane has a hard phase content of from 2% to 4%.
